(19) United States
(12) Patent Application Publication
(10) Pub. No.: US 2012/0328884 A1
(43) Pub. Date: Dec. 27, 2012

(54) Carbon-Based Composite Material and Method for Fabricating the Same

(75) Inventor: I-Nan Lin, New Taipei City (TW)

(73) Assignee: TAMKANG UNIVERSITY, New Taipei City (TW)

(21) Appl. No.: 13/356,963

(22) Filed: Jan. 24, 2012

(30) Foreign Application Priority Data
Jun. 24, 2011 (TW) 100122225

(51) Int. Cl. B32B 9/00; B05D 3/06

(52) U.S. Cl. 428/408; 427/577

(57) ABSTRACT

A method for fabricating a carbon-based composite material includes: (a) forming over a substrate a seeding layer that includes amorphous carbon matrix, and a plurality of ultra-nanocrystalline diamond grains; and (b) growing crystal grains over the seeding layer under a hybrid plasma to obtain the carbon-based composite material. The hybrid plasma is produced by ionization of a gas mixture. The gas mixture includes a hydrocarbon gas, H₂, and an inert gas in a volume ratio of 1:(99−x):x based on 100 parts of the total volume of the gas mixture, and x satisfies 45<x<55. The hydrocarbon gas is selected from CH₄, C₂H₂, and a combination thereof.

### CROSS-REFERENCE TO RELATED APPLICATION

This application claims priority of Taiwanese application no. 100122225, filed on Jun. 24, 2011.

### BACKGROUND OF THE INVENTION

1. Field of the Invention

This invention relates to a carbon-based composite material, more particularly to a carbon-based composite material having excellent field emission (FE) properties, and a method for fabricating the same.

2. Description of the Related Art

Diamond and its related materials, are used in many technical fields due to their specific physical and chemical characteristics. Besides, because a diamond film has excellent electron field emission (EFE) property, it is beneficial to serve as a material for forming field emission emitters. In recent decades, many efforts have been devoted to study the growth, characteristics and applications of single-crystalline andmicrocrystalline diamond (MCD).

A method for fabricating a diamond film has been proposed by the inventors of this application (see “Growth behavior of nanocrystalline diamond films on ultrananocrystalline diamond nuclei: The transmission electronmicroscopy studies,” Journal of Applied Physics 105, 124311 (2009)). The method includes: (A) disposing an n-type silicon substrate in a microwave plasma enhanced chemical vapor deposition (MPECVD) system under Ar/CH₄ plasma condition, in which the volume percentage of CH₄ is 1%, and performing a MPECVD process for 20 minutes so as to form a seed layer having a plurality of ultra-nanocrystalline diamond (UNCD) grains on the silicon substrate; and (B) disposing the silicon substrate having the seed layer in another MPECVD system (2.45 GHz, AS-TeX 5400) and performing a MPECVD process under a working pressure of 73 mbars in a mixed gas atmosphere (CH₄/H₄), in which the volume percentage of CH₄ is 1%, for 60 minutes, so as to obtain a diamond film having a plurality of MCD grains.

The MCD grains of the diamond film have an average size of about 300 nm when observed using Scanning Electron Microscopy (SEM). When observed using Transmission Electron Microscopy (TEM), it is found that each of the MCD grains is surrounded by a plurality of UNCD grains having an average size near 10 nm. After analyzing field emission properties of the diamond film, the turn-on field (E₀) is about 11.1 V/μm.

The turn-on field (E₀) of the aforesaid diamond film is relatively high and further improvement is needed so as to meet requirements for field emission emitters.

### SUMMARY OF THE INVENTION

Therefore, an object of the present invention is to provide a carbon-based composite material and a method for fabricating the same that can overcome the aforesaid drawbacks associated with the prior art.

According to a first aspect of this invention, a method for fabricating a carbon-based composite material comprises:

(a) forming over a substrate a seeding layer that includes amorphous carbon matrix, and a plurality of ultra-nanocrystalline diamond grains dispersed in the amorphous carbon matrix; and

(b) growing crystal grains over the seeding layer in a microwave plasma enhanced chemical vapor deposition system under a hybrid plasma to obtain the carbon-based composite material, the hybrid plasma being produced by ionization of a gas mixture using the microwave plasma enhanced chemical vapor deposition system;

wherein the gas mixture includes a hydrocarbon gas, H₂, and an inert gas in a volume ratio of 1:(99−x):x based on 100 parts of the total volume of the gas mixture, x satisfying 45<x<55, the hydrocarbon gas being selected from CH₄, C₂H₂, and a combination thereof.

According to a second aspect of this invention, a carbon-based composite material comprises:

a carbon matrix;

a plurality of microcrystalline diamond grains dispersed in the carbon matrix; and

a plurality of ultra-nanocrystalline diamond grains dispersed in the carbon matrix and around the microcrystalline diamond grains;

wherein the carbon matrix has nano-graphite clusters that extend to enable the carbon matrix to act as a material for forming field emission emitters, and that are formed by phase-transformed grain boundaries of parts of the microcrystalline diamond grains and the ultra-nanocrystalline diamond grains adjoining the carbon matrix.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a SEM image of an example of a carbon-based composite material (Example 2) obtained using a method according to this invention;

FIG. 2 shows TEM analysis results that illustrate the size and lattice structure of the microcrystalline diamond (MCD) grains of the carbon-based composite material in Example 2 of this invention;

FIG. 3 shows the standard lattice structure and an electron diffraction pattern along the [101] zone axis in a single crystal diamond;

FIG. 4 shows TEM analysis results of the carbon-based composite material in Example 2 according to this invention;

FIG. 5 shows Raman spectra of the carbon-based composite material in Examples 1 to 3 according to this invention;

FIG. 6 is a J versus E plot illustrating the relations between the current density (J) and the electric field (E) in Example 2, and Comparative Examples 1 and 2; and

FIG. 7 is a J versus E plot illustrating the relations between the current density (J) and the electric field (E) in Examples 1 to 3 according to this invention.

### DETAILED DESCRIPTION OF THE PREFERRED EMBODIMENTS

The preferred embodiment of a method for fabricating a carbon-based composite material according to this invention includes (a) a seeding layer forming step, and (b) a crystal grains growing step.

In step (a), a seeding layer is formed over a substrate, and includes amorphous carbon matrix and a plurality of ultra-nanocrystalline diamond (UNCD) grains dispersed in the amorphous carbon matrix.

In step (b), crystal grains are grown over the seeding layer in a microwave plasma enhanced chemical vapor deposition (MPECVD) system under a hybrid plasma to obtain the carbon-based composite material of this invention. The hybrid plasma is produced by ionization of a gas mixture using the MPECVD system.

The gas mixture includes a hydrocarbon gas, H₂, and an inert gas in a volume ratio of 1:(99−x):x based on 100 parts of the total volume of the gas mixture, and x satisfies 45<x<55. The hydrocarbon gas is selected from the group consisting of CH₄, C₂H₂, and a combination thereof.

In step (b), amorphous carbon matrix and the UNCD grains are formed while growing the crystal grains, and a portion of the adjacent UNCD grains aggregate into a plurality of microcrystalline diamond (MCD) grains. Besides, nano-graphite clusters, which extend continuously to enable the carbon matrix to act as a material for forming field emission emitters, and which are interconnected to form a network, are formed by phase-transformed grain boundaries of parts of the MCD grains and the UNCD grains adjoining the carbon matrix.

Preferably, x satisfies 48<x<52, the inert gas is Ar gas, the hydrocarbon gas is CH₄, and the step (b) is conducted for 30 minutes to 90 minutes.

Preferably, the step (a) is conducted in the MPECVD system under Ar/CH₄ plasma condition for 30 minutes to 90 minutes.

The preferred embodiment of a carbon-based composite material is made by the above method, and includes: a carbon matrix; a plurality of MCD grains dispersed in the carbon matrix; and a plurality of UNCD grains dispersed in the carbon matrix and around the MCD grains. The carbon matrix has nano-graphite clusters that extend continuously to enable the carbon matrix to act as a material for forming field emission emitters, and that are formed by phase-trans formed grain boundaries of parts of the MCD grains and the UNCD grains adjoining the carbon matrix.

It should be noted that the inert gas is also introduced into the MPECVD system in step (b). Thus, the amorphous carbon matrix and the UNCD grains are continuously formed. That is to say, the density of the UNCD grains is increased, and the likelihood of the phase transformation can be also increased. Accordingly, the nano-graphite clusters, which are formed from the phase-transformed grain boundaries of the MCD grains and the UNCD grains, have better electrical conductivity, and can serve as interconnecting channels for electrons inside the carbon matrix.

Furthermore, when the size of the UNCD grains becomes smaller, the UNCD grains are more likely to phase-transform into the nano-graphite clusters while the UNCD grains aggregate into the MCD grains. Thus, the UNCD grains preferably have a size ranging from 3 nm to 7 nm.

In this invention, the field emission (FE) mechanism is varied depending on the graphite phase portion of the carbon matrix. When the nano-graphite clusters have proper distribution and amount, it is beneficial to the FE properties of the carbon-based composite material of this invention. Because a part of the nano-graphite clusters is formed by the phase-transformed grain boundaries of parts of the MCD grains, the distribution of the nano-graphite clusters is relative to the size of the MCD grains. Accordingly, the MCD grains preferably have a size ranging from 80 nm to 100 nm. In such condition, the nano-graphite clusters are beneficial for electron transmission and field emission.

### EXAMPLES

### Example 1

A carbon-based composite material of Example 1 (E1) of this invention was made according to the following steps.

An n-type silicon substrate, which has mirror-polished face (001), was subjected to ultrasonic treatment in a solution having diamond powders that have a size of about 1 nm for 30 minutes, and was ultrasonically cleaned using acetone so as to remove residual particles on the substrate.

Then, the substrate was disposed in a microwave plasma enhanced chemical vapor deposition (MPECVD) system, in which the ratio of the CH₄ flowing rate (in unit of sccm) to the Ar flowing rate (in unit of sccm) was 4: 196 (i.e., the volume percentage of CH₄ was 2%). Thereafter, the MPECVD process was conduced in the system for 60 minutes to form a seeding layer on the mirror-polished face (001) of the silicon substrate. The seeding layer includes amorphous carbon matrix, and a plurality of UNCD grains dispersed in the amorphous carbon matrix.

Next, H₂ was introduced into the MPECVD system so that CH₄, H₂, and Ar were in a volume ratio of 1:49:50. Then, the MPECVD process was conducted for 30 minutes under a working pressure of 55 torr to grow crystal grains on the seeding layer. Finally, a carbon-based composite material was obtained.

### Examples 2 and 3

The carbon-based composite materials of Examples 2 and 3 (E2 and E3) were prepared following the procedure employed in Example 1 except that, in the MPECVD process for growing the crystal grains on the seeding layer, the processing time for Examples 2 was 60 minutes and the processing time for Example 3 was 90 minutes.

### Comparative Examples 1 and 2

The carbon-based composite materials of Comparative Examples 1 and 2 (CE1 and CE2) were prepared following the procedure employed in Example 2 except that, in the MPECVD system for growing the crystal grains on the seeding layer, CH₄, H₂, and Ar in Comparative Example 1 were in a volume ratio of 1:24:75, and CH₄, H₂, and Ar in Comparative Example 2 were in a volume ratio of 1:74:25.

<Data Analysis>

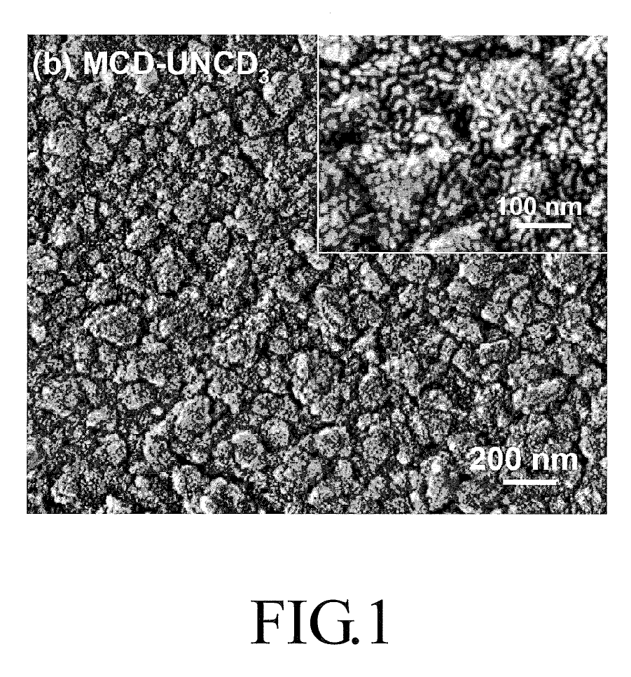

From FIG. 1, which shows a SEM image of the carbon-based composite material of Example 2, it is found that the MCD grains have a size ranging from 80 nm to 110 nm, and that the MCD grains are surrounded by the UNCD grains.

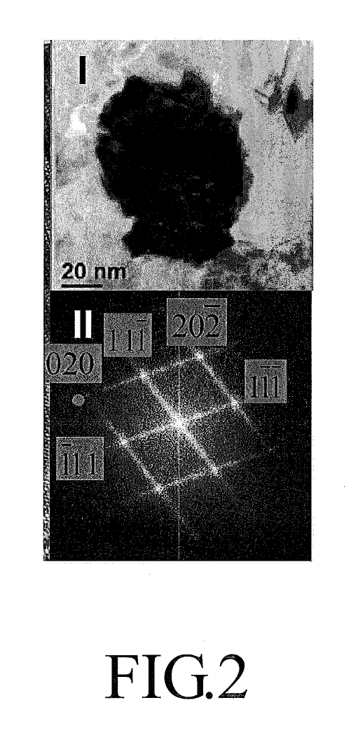

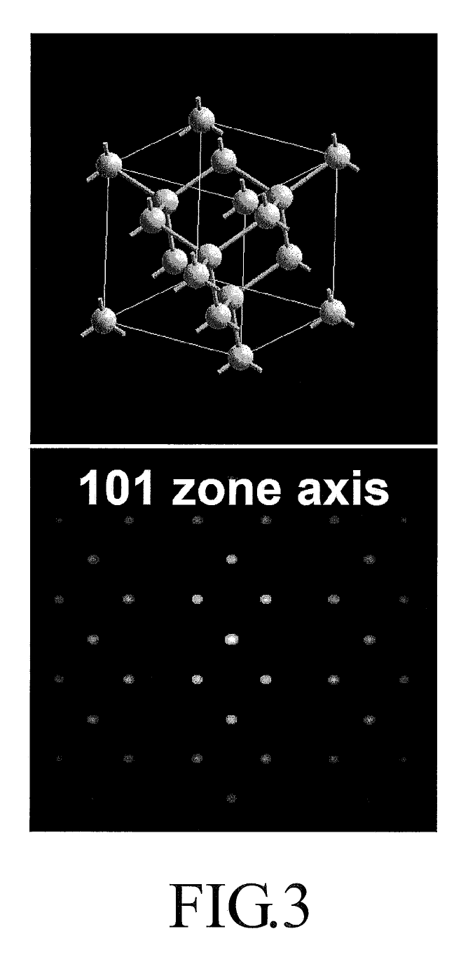

A TEM image of the carbon-based composite material of Example 2 is shown in an upper half of FIG. 2, which shows that the MCD grain has a size of about 90 nm. The lower half of FIG. 2 shows selected area electron diffraction (SAED) pattern for the MCD grains in the carbon-based composite material of Example 2, in which the pattern was obtained along the [101] zone axis. As compared to the standard lattice structure and the electron diffraction pattern along the [101] zone axis for a single crystal diamond (see FIG. 3), the MCD grains in the carbon-based composite material of Example 2 belong to a single crystal diamond with [101] axis orientation.

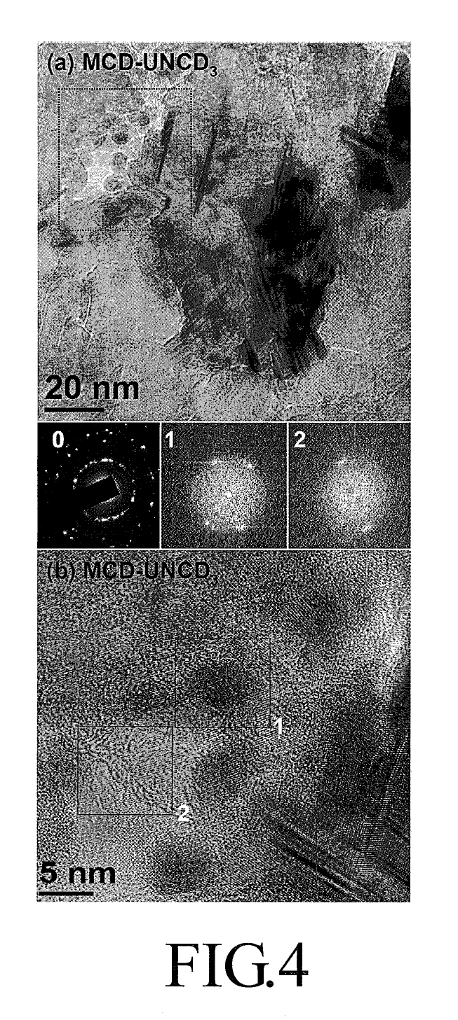

The carbon-based composite material of Example 2 was subjected to TEM analysis at a position away from the [101] zone axis of the MCD grains, and the results are shown in FIG. 4. FIG. 4(b) is an enlarged view of a marked rectangular area in FIG. 4(a). A SAED pattern of the carbon-based composite material in FIG. 4(a) is shown in picture (0) inserted in FIG. 4. It is found that all of the small particles surrounding the MCD grains are the UNCD grains. From FIG. 4(b), it is revealed that the UNCD grains have a size ranging from 3 nm to 5 nm. The Fourier-transformed (FT) diffractograms of the two marked rectangular areas 1 and 2 in FIG. 4(b) are respectively shown in pictures (1) and (2) inserted in FIG. 4. The pictures show that the area 1 has the UNCD grains, and the area 2 is the graphite phase.

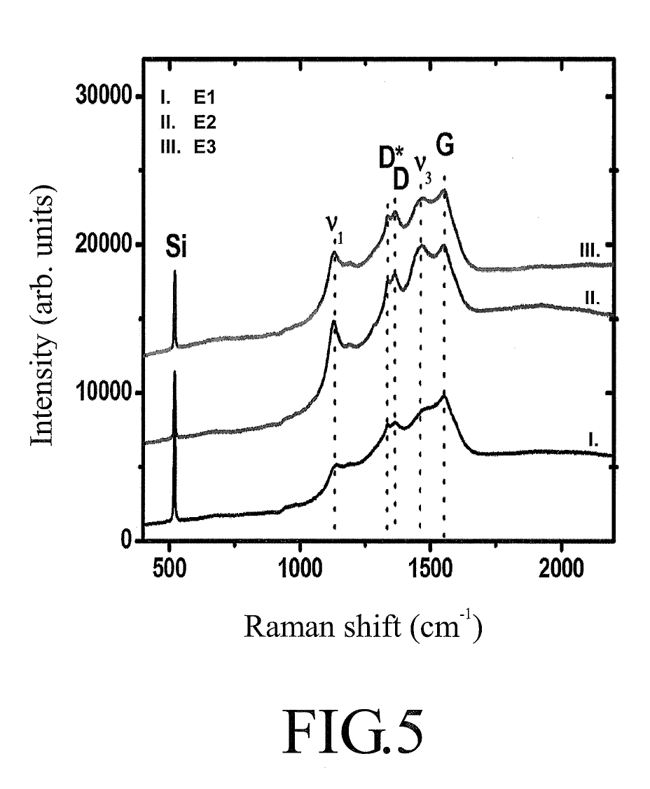

From the Raman spectra shown in FIG. 5, the carbon-based composite materials in Examples 1 to 3 include: resonance peaks of ν₁-band (1140 cm⁻¹) and ν₃-band (1480 cm⁻¹), which represent trans-polyacetylene at the grain boundaries; resonance peaks of D*-band (1350 cm⁻¹) and G-band (1580 cm⁻¹), which represent the existence of disordered carbon and disordered graphite; and a resonance peak of D-band (1332 cm⁻¹).

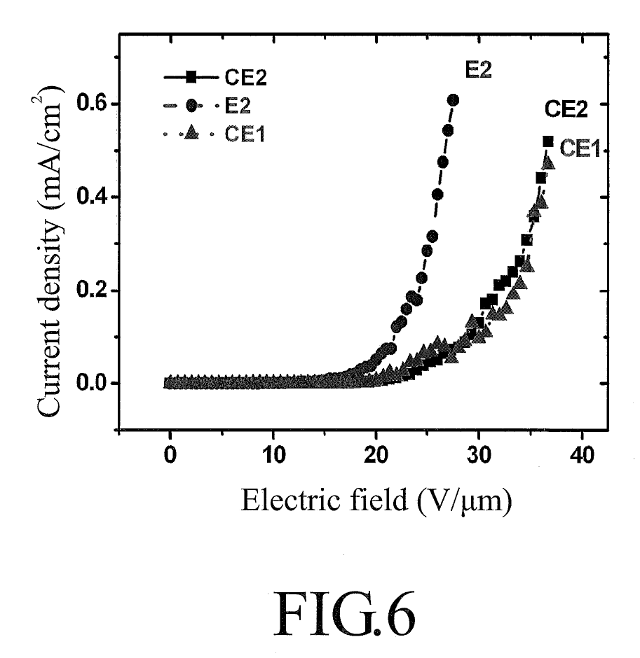

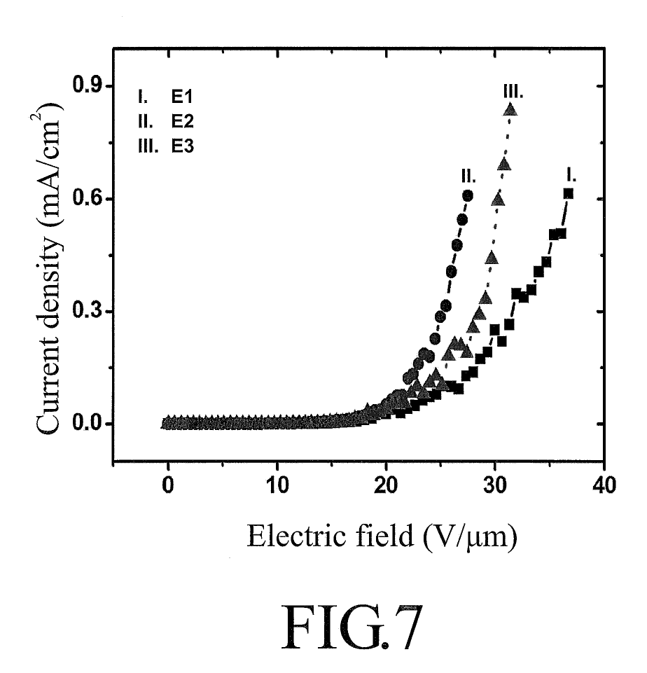

The field emission properties of the carbon-based composite materials for Examples 1 to 3 and Comparative Examples 1 and 2 are shown in FIGS. 6 and 7.

From the current density (J) versus the electric field (E) plot (J vs. E plot) shown in FIG. 6, the turn-on field (E₀) of Example 2 was 6.50 V/μm, and the turn-on fields (E₀) of Comparative Examples 1 and 2 were 15.30 V/μm and 12.70 V/μm, respectively.

From the J vs. E plot shown in FIG. 7, the turn-on fields (E₀) of Examples 1 to 3 range from 6.50 V/μm to 10.86 V/μm.

The parameters and the field emission properties (i.e., turn-on fields (E₀)) of the carbon-based composite materials for Examples 1 to 3 and Comparative Examples 1 and 2 are also shown in Table 1.

TABLE 1

| | The conditions | | The conditions | | |
|---|---|---|---|---|---|
| | for forming | | for growing | | |
| | a seeding layer | | crystal grains | | |
| | | Processing | | Processing | |
| | | time | | time | E₀ value |
| | CH₄:H₂:Ar | (min) | CH₄:H₂:Ar | (min) | (V/μm) |
| CE1 | 4:0:196 | 60 | 1:24:75 | 60 | 15.30 |
| E1 | 4:0:196 | 60 | 1:49:50 | 30 | 10.67 |
| E2 | 4:0:196 | 60 | 1:49:50 | 60 | 6.50 |
| E3 | 4:0:196 | 60 | 1:49:50 | 90 | 10.86 |
| CE2 | 4:0:196 | 60 | 1:74:25 | 60 | 12.70 |

To sum up, the carbon-based composite material of this invention has the continuous graphite phase portion to form the interconnecting channels for transmitting electrons. Besides, with the carbon-based composite material having the continuous nano-graphite clusters formed around the MCD and UNCD grains to serve as emitters for electrical discharge, the turn-on field (E₀) can be reduced.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for fabricating a carbon-based composite material, comprising:
(a) forming over a substrate a seeding layer that includes amorphous carbon matrix, and a plurality of ultra-nanocrystalline diamond grains dispersed in the amorphous carbon matrix; and
(b) growing crystal grains over the seeding layer in a microwave plasma enhanced chemical vapor deposition system under a hybrid plasma to obtain the carbon-based composite material, the hybrid plasma being produced by ionization of a gas mixture using the microwave plasma enhanced chemical vapor deposition system;
wherein the gas mixture includes a hydrocarbon gas, H₂, and an inert gas in a volume ratio of 1:(99−x):x based on 100 parts of the total volume of the gas mixture, x satisfying 45<x<55, the hydrocarbon gas being selected from the group consisting of CH₄, C₂H₂, and a combination thereof.

2. The method of claim 1, wherein x satisfies 48<x<52.

3. The method of claim 1, wherein the inert gas is Ar gas, and the hydrocarbon gas is CH₄.

4. The method of claim 1, wherein step (b) is conducted for 30 minutes to 90 minutes.

5. The method of claim 1, wherein step (a) is conducted in the microwave plasma enhanced chemical vapor deposition system under Ar/CH₄ plasma condition for 30 minutes to 90 minutes.

6. A carbon-based composite material comprising:
a carbon matrix;
a plurality of microcrystalline diamond grains dispersed in said carbon matrix; and
a plurality of ultra-nanocrystalline diamond grains dispersed in said carbon matrix and around said microcrystalline diamond grains;
wherein said carbon matrix has nano-graphite clusters that extend to enable said carbon matrix to act as a material for forming field emission emitters, and that are formed by phase-transformed grain boundaries of parts of said microcrystalline diamond grains and said ultra-nanocrystalline diamond grains adjoining said carbon matrix.

7. The carbon-based composite material of claim 6, wherein the phase transformation of the grain boundaries is conducted in a microwave plasma enhanced chemical vapor deposition system under a hybrid plasma, said hybrid plasma being produced by ionization of a gas mixture using the microwave plasma enhanced chemical vapor deposition system; and
wherein the gas mixture includes a hydrocarbon gas, H₂, and an inert gas in a volume ratio of 1:(99−x):x based on 100 parts of the total volume of the gas mixture, x satisfying 45<x<55, the hydrocarbon gas being selected from the group consisting of CH₄, C₂H₂, and a combination thereof.

8. The carbon-based composite material of claim 7, wherein x satisfies 48<x<52.

9. The carbon-based composite material of claim 7, wherein the inert gas is Ar gas, and the hydrocarbon gas is CH₄.

10. The carbon-based composite material of claim 6, wherein said microcrystalline diamond grains have a size ranging from 80 nm to 110 nm, and said ultra-nanocrystalline diamond grains have a size ranging from 3 nm to 7 nm.

11. A carbon-based composite material fabricated according to the method of claim 1.
